(19) United States
(12) Patent Application Publication
(10) Pub. No.: US 2025/0154440 A1
(43) Pub. Date: May 15, 2025

(54) Probiotic Cleaning Composition and Method of Making and Using the Same

(71) Applicant: Energizer Brands, LLC, St. Louis, MO (US)

(72) Inventor: Sandra Nicholson Porter, Huntersville, NC (US)

(73) Assignee: Energizer Brands, LLC, St. Louis, MO (US)

(21) Appl. No.: 18/942,074

(22) Filed: Nov. 8, 2024

Related U.S. Application Data
(60) Provisional application No. 63/598,470, filed on Nov. 13, 2023.
(60) Provisional application No. 63/597,982, filed on Nov. 10, 2023.

(51) Int. Cl. C11D 3/38; C11D 1/14; C11D 1/66; C11D 1/83; C11D 3/04; C11D 3/20; C11D 3/39; C11D 3/50

(52) U.S. Cl. CPC C11D 3/381; C11D 1/83; C11D 3/042; C11D 3/2086; C11D 3/3942; C11D 3/50; C11D 1/146; C11D 1/662

(57) ABSTRACT

The present disclosure describes cleaning and treating formulations including components that interact together to form stable combinations of hydrogen peroxide and a probiotic bacterial solution to provide an immediate oxidative cleaning or treatment effect and a residual antimicrobial effect when applied to a substrate. Cleaning and treating formulations of the present disclosure may include about 0.05% to about 7.00% of hydrogen peroxide, about 5.0×10⁴ to about 5.5×10⁸ cfu/ml of bacterial spores, about 0.20% to about 6.00% of a surfactant; and about 78.00% to about 84.00% of an aqueous carrier. The formulation may also include about 0.01% to about 0.05% of a stabilizer, such as an acid-based stabilizer, and about 0.05% to about 2.00% of a buffer system to control pH fluctuation over the shelf life of the product. Furthermore, formulations may include a fragrance, odor neutralizer, and/or malodor counteractant; and optional ingredients which do not adversely affect the composition.

### CROSS-REFERENCE TO RELATED APPLICATIONS

This application claims the benefit of U.S. Provisional Application No. 63/597,982, filed Nov. 10, 2023, and U.S. Provisional Application No. 63/598,470, filed Nov. 13, 2023, which are both incorporated herein by reference in their entirety.

### FIELD OF THE DISCLOSURE

The present disclosure discloses formulations for cleaning and treating surfaces, including fabrics. The present disclosure also discloses methods for preparing the formulations and methods for cleaning and treating surfaces, including fabrics, using the formulations.

### BACKGROUND OF THE DISCLOSURE

Fabrics and fibers are subject to various types of soils and odors, which can impact their texture, color, and longevity. Soil types that affect textiles are often classified into categories such as particulate soils, oily soils, protein-based soils, and tannin-based soils. Particulate soils, like dust and dirt, are small solid particles that adhere to fibers and can dull the appearance of fabrics, especially light-colored ones. Oily soils, on the other hand, are caused by substances like cooking oils, body oils, and makeup, which cling to synthetic fibers like polyester, making them challenging to remove. Protein-based soils, from sources like sweat, blood, and food, can penetrate deeply into fabrics and cause discoloration and lingering odors. Lastly, tannin-based soils come from plant-based materials such as coffee, tea, and wine and tend to leave noticeable stains that can be tough to lift if left untreated.

Odors in fabrics and fibers are commonly associated with the type of soil embedded in the material. Body oils, sweat, and food-related substances can produce odors as they degrade over time, especially in fabrics and fibers, which can absorb and hold onto smells. Moist environments may also cause fabrics to develop a musty odor due to mildew or mold, which can be particularly difficult to eliminate from porous fibers. Additionally, synthetic fibers, while generally less absorbent, can trap certain volatile compounds, holding onto strong scents from smoke or cooking. Different odors often require specific treatments to break down the odor-causing compounds without damaging the fabric.

Conventional cleaning methods for removing soils vary based on the type and intensity of the stain. For particulate soils, a basic wash with detergent is often sufficient, but using warm water can enhance the detergent's cleaning power to lift the particles effectively. Oily soils typically require pre-treatment with a degreasing agent or heavy-duty detergent, as oils repel water and need extra emulsifying action to detach from fibers. Protein-based soils often require cold water during the pre-treatment phase to prevent setting, followed by a stain-specific enzyme cleaner that breaks down the proteins. Tannin-based soils are best tackled immediately with a mild detergent or diluted vinegar solution, which helps neutralize the stain without spreading it further into the fibers.

Odor removal techniques generally depend on the source of the odor. For body and sweat odors, adding a cup of white vinegar or baking soda to the wash cycle can help neutralize acidic smells. To address mildew or musty odors, a longer wash cycle with hot water, combined with oxygen bleach or a specialized disinfectant, is effective. For synthetic fabrics that trap persistent scents, using a detergent with odor-eliminating enzymes or fabric refreshers can help. Smoke odors, which penetrate deeply into fibers, may require multiple washes or the use of activated charcoal products to absorb the scent. Conventional cleaning methods can be effective, but certain soils and odors may benefit from professional cleaning for deeper sanitation without damaging delicate fabrics.

### SUMMARY OF THE DISCLOSURE

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes cleaning and treating formulations including components that interact together to form stable combinations of hydrogen peroxide and a probiotic bacterial solution to provide an immediate oxidative cleaning or treatment effect and a residual antimicrobial effect when applied to a substrate.

Cleaning and treating formulations of the present disclosure may include about 0.05% to about 7.00% of hydrogen peroxide, about 5.0×10⁴ to about 5.5×10⁸ cfu/ml of bacterial spores, about 0.20% to about 6.00% of a surfactant; and about 78.00% to about 84.00% of an aqueous carrier. The formulation may also include about 0.01% to about 0.05% of a stabilizer, such as an acid-based stabilizer, and about 0.05% to about 2.00% of a buffer system to control pH fluctuation over the shelf life of the product. Furthermore, formulations described herein may include a fragrance, odor neutralizer, and/or a malodor counteractant; and optional standard ingredients which do not adversely affect the performance or stability of the formulation.

### DETAILED DESCRIPTION

The present disclosure describes methods and chemical compositions/formulations that effectively clean and treat fabrics. Compositions of the present disclosure provide immediate cleaning and extended cleaning.

The terms “composition” and “formulation” and also their plural forms are used interchangeably to refer to various compositions described herein.

Formulations of the present disclosure include shelf-stable combinations of hydrogen peroxide and a bacterial spore composition to provide an immediate oxidative cleaning or treatment effect and a residual antimicrobial effect when applied to a substrate. For the present disclosure “stable and compatible” means that the formulations must have a shelf stability of at least one year. In embodiments, the bacterial spores are probiotics. The probiotics may be in a spore form and/or a dormant form. Probiotics in spore or dormant form do not provide an instant effect against microbes, odor, stains, or soils. Probiotics in spore or dormant form need to germinate/vegetate and establish biofilms on substrates after application to become active agents. Hydrogen peroxide, on the other hand, provides an instant effect upon application, such as an antimicrobial effect, as well as soil and/or odor removal. The formulations of the present disclosure can be used in various ways including, for example, as a fabric refresher, a disinfectant, or a cleaning agent.

The term “probiotics” and “bacterial spore probiotics” are used interchangeably herein to refer to “bacterial spore probiotics”.

The term “substrate” herein is used to mean any surface or object that the formulations of the present disclosure may be applied to provide effective cleaning, disinfecting, malodor elimination, and a lasting cleaning effect. Substrates include usage areas and sites of application for formulations of the present disclosure. Substrates can include hard and soft surfaces for cleaning, disinfection, and odor control. In embodiments, a substrate may include hard surfaces in a bathroom, such as a sink, a toilet, a bathtub, walls, countertops, cabinets, and floors. In embodiments, a substrate may include hard surfaces in a kitchen or food preparation area, such as counters, appliances, walls, and floors. In embodiments, a substrate may include hard surfaces in a laundry processing area, such as counters, appliances, walls, and floors. In embodiments, a substrate may be in a domestic or an industrial setting. In embodiments, substrates can include soft surfaces such as upholstery, textiles, and fabrics. In embodiments, substrates may include synthetic upholstery, textiles, and fabrics which are resistant to damage and deterioration caused by oxidation.

In order to provide the long-lasting residual cleaning effect, cleaning and treating formulations of the present disclosure may need to be left on the surface of a substrate for a certain amount of time, for example about 20 minutes, without rinsing, so the probiotics may germinate and/or vegetate to form a biofilm. In embodiments, the cleaning and treating formulations of the present disclosure may be left on the surface of a substrate from about 10 minutes to about 2 hours, from about 15 minutes to about 1 hour, or from about 20 minutes to about 30 minutes. In embodiments, the cleaning and treating of the substrate with the formulations described herein are performed without rinsing. Once the probiotics vegetate and form a biofilm, they become resistant to subsequent rinsing and disruption, such as wiping and scrubbing, of the surface. For example, probiotics on the surface of a substrate may be active for hours, days, weeks, months, or years, such that the substrate remains cleaned and refreshed without having to reapply the formulation. In essence, once the probiotics form a biofilm, they continue growing and generating enzymes that consume contaminants until all contaminants are depleted.

The term “contaminants” as used herein refers to any substance that make a system or substrate less pure, less clean, or unsuitable for use.

Hydrogen peroxide is a reactive chemical that can break down common household and industrial soils and stains, and eliminate malodors at their source. It works effectively on hard surfaces as well as on both light and colored fabrics to remove stains caused by protein-based soils like blood and sweat, and organic stains such as coffee, wine, and grass. Hydrogen peroxide can also be used as a disinfectant as it can destroy pathogenic microorganisms. The chemical properties of hydrogen peroxide make it safer and less harsh for disinfecting, cleaning, and bleaching surfaces and fibers than, for example, chlorine bleach. Hydrogen peroxide can be particularly useful for white fabrics as it brightens them without causing yellowing.

Currently, the most widely used group of antimicrobial actives for household disinfectants are quaternary ammonium compounds (quats). Quats, however, have the key disadvantage that they are residual and stay behind on surfaces after applications. Soils can be attracted to the residual quats which causes a build-up of soiling. Additionally, residual quats result in repeated human exposure to quats chemicals every time the surface is touched after cleaning, and negative health effects have been reported from repeated exposure to quats. An attractive alternative to conventional cleaners such as quats is hydrogen peroxide. After chemical reactions take place to break down soils, odors, and microorganisms, hydrogen peroxide (H₂O₂) breaks down into water and oxygen. This results in little to no residue as the water evaporates and the oxygen leaves as oxygen gas. This property makes hydrogen peroxide a very “green” chemistry with respect to safety and environmental impact. Hydrogen peroxide can work in disinfectants by acting directly on microorganisms, such as bacteria, viruses, and fungi. It chemically produces destructive hydroxyl free radicals that can attack membrane lipids, DNA and other essential cell structures then leaves behind only water and oxygen.

Hydrogen peroxide can perform a cleaning function by oxidizing dirt stains and germs on surfaces. The molecules are broken down into smaller pieces and their bonds to surfaces are weakened by oxidation. Bubbling, that occurs as oxygen gas comes off during oxidation, helps to physically dislodge soils and particles. The dislodged particles and molecules of dirt, stains, and soils are then lifted for removal, for example with rinsing. Malodor-causing molecules are often organic (containing carbon atoms), and they can have double bonds, sulfur groups, and/or other functional groups that contribute to an unpleasant smell. For example, hydrogen peroxide can directly oxidize malodor molecules such as hydrogen sulfide (H₂S) which has a rotten egg smell—removing the malodor. The basic reaction for hydrogen peroxide with hydrogen sulfide is as follows:

H₂O₂+H₂S→S+2H₂O

While hydrogen peroxide offers many advantages, it has some limitations as well. Hydrogen peroxide is short-acting, and the cleaning action is limited to the time it takes to oxidize. On heavily soiled substrates, this results in soils, odors, and stains remaining if too little hydrogen peroxide is applied. Using a higher concentration of hydrogen peroxide to provide adequate cleaning and odor elimination, however, increases the potential for discoloration and/or damage to the substrate. While generally safe for most surfaces and colorfast fabrics, hydrogen peroxide can fade colors on delicate or dyed fabrics if used in high concentrations or left on for too long. It can also weaken fibers if used excessively, especially on natural fabrics like leather, silk, cotton, and wool.

Bacterial spores and probiotics are an innovative approach in cleaning, harnessing beneficial bacteria to break down organic matter and eliminate odors. In probiotic bacterial spore cleaning products, live bacterial cultures are introduced onto the substrate, where they produce enzymes that digest soils, sweat, and other organic residues at a microscopic level. For example, the probiotic may produce enzymes, such as amylase, cellulase, lipase, urease, protease, which breakdown protein, starches, carbohydrates, cellulose, urine, fats, oils, greases and other organic substances. Once the bacterial spores form a biofilm, the enzymes produced by the bacterial spores continue working even after rinsing or washing, creating a long-lasting cleaning effect and prevent odors from reforming over time. Probiotic bacterial spores are also environmentally friendly and non-toxic, making them ideal for those seeking green cleaning solutions. Probiotic bacterial spore cleaners may be slower to start working compared to conventional cleaning agents, as the bacteria need time to activate and digest the soils, but they can continue working for a longer period of time. Additionally, probiotic cleaners must be stored carefully, as extreme temperatures and harsh chemicals can kill the bacteria.

Cleaning and treating formulations of the present disclosure include stable combinations of hydrogen peroxide and a bacterial spore composition to provide an immediate oxidative cleaning or treatment effect and a residual longer-lasting antimicrobial effect when applied to a substrate as compared to known cleaners. The bacterial spores remain dormant in the presence of hydrogen peroxide. Once the hydrogen peroxide decomposes, the bacterial spores become active. In embodiments, the bacterial spores are live probiotics. The probiotics used in the formulations can be a composition in the form of a solution comprising stabilized Bacillus spores. The probiotic composition can include a multi-spore bacterial blend including Bacillus pumilus, Bacillus amyloliquefaciens, Bacillus licheniformis and Bacillus subtilis. In embodiments, the Bacillus subtilis includes Bacillus subtilis subspecies inaquosorum.

Probiotics in spore or dormant form do not provide an instant effect against microbes, odor, stains, or soils. Probiotics in spore or dormant form need time to germinate/vegetate and establish biofilms on substrates after application. Spore or dormant probiotics of the present formulations can be activated when applied into a moist, nutrient rich environment in which they are able to anchor to and colonize on a soiled substrate and form a biofilm. The probiotics proliferate as they feed on organic soils, helping to counteract the growth of other unwanted microbial species through competitive exclusion. As the probiotic species becomes established in a system or on the surface of the substrate, as tenacious biofilms, the probiotics produce enzymes which breakdown a variety of soils and contaminants in the system or substrate. The breakdown of soils and contaminants continues as long as there is moisture, warmth, food source, and darkness for the probiotic to feed on and grow. As the probiotic bacteria grow, competitive exclusion takes place to kill or inhibit the undesirable bacteria, for example, those that produce contaminants in a soiled substrate or system. In embodiments, the cleaning continues as long as the probiotic bacteria continue to grow or until dehydration transforms the probiotics back into the dormant spore form.

Based on this performance mechanism, probiotics are used to provide long-lasting cleaning on a microscopic level after the initial application of the formulation to a substrate. The probiotics can become enzyme factories in the system or on the surface of a substrate that keep breaking down and removing many different types of contaminants long after application. Enzymes produced by the probiotics provide the advantage of getting into tiny crevices and fine grooves of a substrate that may be inaccessible to other cleaning methods and they can keep working for days after application.

In embodiments, the formulations described herein include probiotics in chemically inactive, spore form, which can be combined with other ingredients to provide a fully functional cleaning product. In embodiments, the formulation is tailored to the substrate, the type of application area, and associated soils, contaminants, and residues. Because the use of probiotics includes a delay due to time to activate, proliferate, and produce enzymes to begin the digestion and cleaning process, formulations described herein include other immediately active agents including hydrogen peroxide, soil/stain removers, and surfactants. In the case of odor control products, a fragrance, odor neutralizer, and/or a chemical or enzymatic malodor counteractant can be included in the formulation. The fragrance can mask the odor and the odor neutralizer and malodor counteractant can immediately eliminate odors. The probiotics provide long-lasting effects as they break down odors and compete with the growth of odor-causing bacteria to stop odor at the source.

In embodiments, formulations include hydrogen peroxide combined with probiotics in spore or dormant form. For the present disclosure, formulation including probiotics in spore or dormant form are shelf stable and compatible with hydrogen peroxide. Although hydrogen peroxide and probiotics can provide the complementary and advantageous effects described above: wherein hydrogen peroxide can provide an instant effect upon application, such as an antimicrobial effect, as well as soil and/or odor removal, and probiotics can provide a long-lasting cleaning effect. Hydrogen peroxide is a natural antimicrobial, and formulations combining hydrogen peroxide with live probiotics would expectedly be ineffective because the hydrogen peroxide would kill the probiotics. The present disclosure, however, provides live probiotics and hydrogen peroxide combinations in a stable and compatible formulations.

The cleaning and treating formulations of the present disclosure include hydrogen peroxide bacterial spores, and an aqueous carrier. In embodiments, the formulations include a surfactant, a stabilizer, a buffer system to control pH fluctuation over the shelf life of the product, and/or a fragrance, odor neutralizer, and/or malodor counteractant. The formulation can also include optional standard ingredients which do not adversely affect the performance or stability of the formulation.

### (A) Hydrogen Peroxide

In embodiments, the cleaning and treating formulations described herein can include hydrogen peroxide in a range from about 0.05% to about 7% w/w. In embodiments, the formulations include hydrogen peroxide in a range from about 0.5% to about 3.0% w/w. In embodiments, the formulations include about 0.15%, about 0.25%, about 2.4%, or about 1.5% w/w hydrogen peroxide. Hydrogen peroxide is sold commercially in aqueous solution and may be in the form of a solution, such as, 50% hydrogen peroxide, 35% hydrogen peroxide, or 27% hydrogen peroxide. For example, hydrogen peroxide is commercially available under the name of Super D 50%, 35%, or 27% from FMC Corporation may be used. Other similar hydrogen peroxide commercially available products are also available. Formulations of the present disclosure may use medical grade hydrogen peroxide. For example, a 50% aqueous hydrogen peroxide solution may be employed in a range of 0.1 to 14% w/w, a 35% aqueous hydrogen peroxide solution may be employed in a range of about 0.1 to about 20% w/w, and a 27% aqueous hydrogen peroxide solution may be employed in a range of about 0.2 to about 26% w/w. At the specified range of hydrogen peroxide, the formulations are safe for use in indoor environments around humans and pets and will not corrode metal or fade or damage fabrics.

### (B) Bacterial Spores

In embodiments, the bacterial spores of the present formulation are probiotics as described herein. In embodiments, the bacterial spores are dormant. In embodiments, the bacterial spores may include Bacillus spores. For example, bacterial spores include spores of at least one of Bacillus subtilis, Bacillus licheniformis, Bacillus pumilus, Bacillus amyloliquefaciens (Bacillus velezensis), Bacillus megaterium, Bacillus atrophaeus, Bacillus mojavensis, Bacillus paralicheniformis, Bacillus thuringiensis, or a combination thereof. The formulation may contain a multi-spore bacterial blend. The multi-spore bacterial blend may include spores from Bacillus pumilus, Bacillus amyloliquefaciens, Bacillus licheniformis and Bacillus subtilis, and optionally wherein the Bacillus subtilis includes Bacillus subtilis subspecies inaquosorum.

Bacterial spores may be sold commercially in a concentrated solution and may be in the form of a solution, such as, Bacilox® XL 10× concentrate. In embodiments, the probiotic composition is about 9% to about 11% Bacilox® XL 10× concentrate having a bacterial cell count of about 5.5×10⁸ cfu/ml before dilution (Bacilox® XL). In embodiments, a colony-forming unit (cfu) of the bacterial spores may include about 5.0×10⁴ to about 5.5×10⁸ cfu/ml. Further information regarding effective probiotic concentrations may be found in WO 2021/243324 A1, which is incorporated herein by reference. This reference discusses microbial cleaning compositions and the problem of immediate cleaning efficacy using surfactants for cleaning in microbial (probiotic) cleaners. This reference has a minimum of 10⁴ cfu/ml, and preferably 10¹ cfu/ml Bacillus spores for efficacy in a cleaning product. Bacilox® XL is multi-spore bacterial blend may include spores from Bacillus pumilus, Bacillus amyloliquefaciens, Bacillus licheniformis and Bacillus subtilis subspecies inaquosorum.

### (C) Surfactant

A surfactant is a compound that lowers the surface tension of water, thereby imparting associated functional properties when incorporated into an aqueous solution including wetting/spreading of product upon application and solubilization of non-water soluble components such as a fragrance in an aqueous carrier. In embodiments, the surfactant in the cleaning and treatment formulation be both an emulsifier and a surfactant such as a sorbitol based emulsifier and surfactant. In embodiments, an emulsifier/surfactant may include a nonionic surfactant, such as polyoxyethylene sorbitan monostearate or PEG-20 sorbitan laurate; commonly known as polysorbate 20; commercially supplied under trade name Tween® 20 by Croda. Alternate trade name sources of polysorbate 20 are also available. In embodiments, polysorbate 20 may be used in the formulation in a range of about 2.5 to about 7.5% w/w based on the weight of the total formulation. In embodiments, polysorbate 20 may be used in the formulation at about 5.0% w/w.

Surfactant class is not limited to nonionic but can be anionic, cationic, amphoteric or zwitterionic. The one or more surfactants in the formulations described herein are compatible and/or stable with hydrogen peroxide and the other components. Moreover many other types of surfactants may be suitable provided they are functional as solubilizers and wetting agents and stable with hydrogen peroxide and other components of the present description. An example of an anionic surfactant in accordance with embodiments of the present description is sodium lauryl sulfate (SLS). In embodiments, SLS may be used in the formulation in a range of about 0.10 to 1.0 about w/w based on the weight of the total formulation. In embodiments, SLS may be used in the formulation at about 0.45% w/w. In embodiments, the surfactant may include an alkyl polyglucoside (APG). Alkyl polyglycosides (APG) are a class of nonionic surfactants widely used in a variety of applications. They are derived from sugars and readily biodegradable. The APG can be a hexyl glucoside, for example Sucranov™ HG-NAT. In embodiments, the APG may be used in the formulation in a range of about 1.0 to about 5% w/w based on the weight of the total formulation. In embodiments, the APG may be used in the formulation at about 2.5% w/w.

The surfactants used in the formulations described herein can include a combination of one or more cationic, anionic, nonionic, and/or zwitterionic surfactants. In embodiments, the combination of surfactants comprises anionic and nonionic surfactants.

In embodiments, the surfactant can be IVS-34 which is a blend comprising both nonionic and anionic chemistry. In embodiments, the surfactant, including IVS-34, may be used in the formulation in a range of about 0.5 to about 5.0% w/w based on the weight of the total formulation. In embodiments, the surfactant, including IVS-34, may be used in the formulation at about 1.3% w/w. The usage range for other suitable surfactants would depend upon the nature of the surfactant and the amount and composition of water-insoluble components to be solubilized. In embodiments, one or more surfactants may be used in the formulation such that the combination of all surfactants in the formulations are in the range of about 0.1 to about 10.0% w/w, based on the weight of the total formulation.

### (D) Aqueous Carrier

In embodiments, the remainder of the formulation is the aqueous carrier/solvent. In embodiments, the aqueous carrier/solvent is water, such as deionized water. The quantity of water in the formulation is an amount sufficient for the ingredients in the formulation to total 100% w/w. Additional optional ingredients would reduce the quantity of water by the total % wt. of such added ingredients so that the total formulation is 100% w/w.

### (E) Stabilizer

In embodiments, the formulation may contain a stabilizer. The stabilizer can be an acid-based stabilizer, which can include a mixture of more than one acid and/or salt. The function of the stabilizer is to enhance the stability of the hydrogen peroxide in solution while maintaining its oxidation capacity upon application. Phosphorous based acids and salts thereof may be used and may be inorganic or organic. In embodiments, phosphoric acid and phosphonates may be used. In embodiments, the phosphorus based acids and/or salts may be employed in a range of about 0.008% to about 0.60% w/w based on the weight of the formulation. In embodiments, phosphorus based acids and/or salts may be employed at about 0.02% w/w. Phosphoric acid is commercially available in aqueous solution. For example, phosphoric acid 85% w/w (aqueous solution) may be used in the embodiments of the present disclosure. Therefore, the range of an 85% aqueous solution of phosphoric acid may be about 0.01 to about 0.70% w/w.

### (F) Buffer

In embodiments, a buffer system to control fluctuating pH over the shelf life of a product may also be present. The preferred buffer may include citric acid and/or sodium citrate (the sodium salt of citric acid). In embodiments, the total amount of buffer system employed in the formulations may be in a range of about 0.1 to about 0.4% w/w based on the weight of the formulation and provides a pH in a range of about 2.0 to about 6.0. In embodiments, the buffer system may include citric acid at about 0.07% w/w and sodium citrate at about 0.19%, and a pH in a range of about 4.5 to 5.5. In embodiments, the buffer system may include citric acid at about 1.0% w/w and a pH in a range of about 2 to 3. Other buffer systems compatible with all the components of the formulation, and suitable for embodiments of the present disclosure include organic and inorganic acids and their salts where the ratio of acid to salt and the total amount of buffer system in the formulation are determined by the type of acid and the desired pH.

### (G) Fragrance, Odor Neutralizer, and Malodor Counteractant

In embodiments, the one or more agents can include a fragrance and/or an odor neutralizer. In embodiments, the fragrance, malodor counteractant, and/or odor neutralizer provide an immediate effect. The term fragrance as used in consumer products typically refers to a mixture of many individual chemical components custom blended to deliver a particular scent that masks odors. Fragrance components, such as fragrance oils, may be extracted from natural aromatic sources such as flowers (e.g., lavender, lilac, rose, jasmine, gardenia), trees (e.g., pine or vanilla scents), or food such as melon or berries. Formulated fragrances may be synthetic, natural or mixtures of synthetic and natural components.

In embodiments, the malodor counteractants and odor neutralizers eliminate undesirable odors. They destroy the source of the odor and create a new compound with a different scent. In embodiments, the formulation may include malodor counteractant and/or odor neutralizer ingredient(s) which absorb, adsorb, encapsulate, entrap or otherwise complex with malodor molecules to reduce volatility or otherwise interfere with the perception of the malodor. U.S. Pat. No. 9,149,550B2 discloses a stable, aqueous freshener composition for the reduction or elimination of malodors in air and on fabrics. This reference is incorporated by reference herein. Formulating a desirable scent is a difficult task since several common perfume ingredients, for instance aldehydes, can be unstable. Therefore, formulations may include any fragrance, malodor counteractant, and/or odor neutralizer that has been tested and deemed stable in the fabric refresher with hydrogen peroxide in it. For example, formulations may include a malodor counteractant such as undecylenic acid and/or derivatives thereof, including methyl undecylenate and ethyl undecylenate.

Additional odor neutralization ingredients and fragrances may be employed in place of the compositions disclosed in U.S. Pat. No. 9,149,550 B2 and herein provided they are stable and compatible with hydrogen peroxide and other ingredients of the formulation. For example, the formulation may be a fabric refresher formulation, wherein the formulation can include a linen fragrance such as sun-dried linen fragrance oil to provide a newly laundered linen scent.

### (H) Other Optional Ingredients

Standard optional ingredients may be contained in formulations of the present disclosure provided they do not adversely affect the performance or stability of the formulation. Examples of optional ingredients include adjunct fragrance and odor-control agents, stabilizing agents, solubilizing agents, odor-control agents, solvents (including alcohols), antimicrobials, antioxidants, colorants, antifoaming agents and mixtures thereof. The total of all optional ingredients can be up to about 6 wt. %, based on the weight of the formulation. In embodiments, the total of all optional ingredients is up to about 1 wt. %.

In embodiments, the formulations described herein do not include herein do not include dyes, phthalates, or formaldehydes.

The formulations described herein can be formulated in the form of a liquid. The liquid can be dispensed in bottles, including trigger spray bottles, such that the liquid can be applied to substrates by spraying. The liquid can also be applied onto an applicator, such as a sponge, cloth, paper towel, nicrofiber towel, or a combination for applying on the substrate.

The formulations described herein can also be formulated in powder form or tablet form. A powder or a tablet formulated to provide instant and long-lasting cleaning and treatment effects may be inactive when dry and/or in tablet form. Instant effects of the formulation in powder form or tablet form may become active when the powder or tablet is exposed to water. In embodiments, a powder or a tablet of the present disclosure may be formulated with sodium percarbonate such that when the powder or tablet is exposed to water, the sodium percarbonate releases hydrogen peroxide to provide an instant cleaning and treatment effect. In embodiments, the long-lasting effects of the formulation in powder form or tablet form may become active when the powder or tablet is exposed to water. A powder or a tablet of the present disclosure may be formulated with dry probiotics in spore/dormant form such that when the powder or tablet is exposed to water and a substrate, the probiotic spores germinate/vegetate and establish biofilms on the substrate and thereby providing a long-lasting instant cleaning and treatment effect.

In embodiments, a powder or tablet formulation as described herein may be made by following the steps of: making a probiotic spore powder, such as a bacillus spore powder; mixing the spore powder with a diluting carrier; and activating the spores in water. In embodiments, bacterial probiotic spores processed into powder form are first cultivated. The bacterial probiotic spores, for example Bacillus bacteria, may be cultivated in a controlled environment, allowing them to grow and eventually enter the spore phase. In embodiments, after cultivation the bacterial spores are harvested and then dried, for example using processes like spray drying or freeze drying, which preserves their viability and stability. In embodiments, the dried bacterial spores are milled into a fine powder. The dried bacterial spores, such as bacillus spores, like those from Bacillus subtilis or Bacillus coagulans, are resilient and can withstand being milled into a powder.

In embodiments, the powdered spores can then be blended with a carrier. In embodiments, carriers may be mixed with the spore powder to ensure consistency, stability, and ease of use and create a uniform mixture that's easy to handle and measure. In embodiments, carriers may include maltodextrin, rice flour, cornstarch, inulin, microcrystalline cellulose, or combinations thereof. Maltodextrin is water-soluble, inexpensive, and has a neutral taste. Rice flour and cornstarch are natural, stable, and easy to blend with the powder without affecting the spores. Inulin is a fiber-based carrier that can be used when prebiotic benefits are desired alongside the probiotic. Microcrystalline cellulose is an inert carrier and commonly used in dietary supplements and has excellent flow properties.

In powder form, bacterial spores, such as Bacillus spores, are dormant and become active when they encounter the right environment, such as water, as part of their life cycle. In embodiments, the activation process includes hydration, nutrient sensing, and germination and metabolism. When the spore powder is mixed with water, the spores absorb moisture, which may begin the activation process. This hydration initiates a physiological change, allowing the spores to start germinating. In embodiments, the hydrated spores sense nutrients in the water and/or in the application environment, which may trigger germination and metabolism. Within minutes to hours, the spores exit their dormant state and become vegetative cells, ready to metabolize, multiply, and produce enzymes, which makes them effective for their intended purpose. This process allows probiotic spores, such as Bacillus spores, to remain stable in powder form yet easily activate when rehydrated, making them ideal for applications in probiotics, cleaning, or agricultural products.

An example of a formulation for refreshing fabrics can include hydrogen peroxide (as described herein), probiotics (as described herein), a sorbitol based emulsifier/surfactant (Polysorbate 20), a sun-dried linen fragrance oil, an acid that stabilizes hydrogen peroxide (phosphoric acid), a buffer system (citric acid and sodium citrate), and an aqueous carrier (distilled water). An example of a formulation for use as a disinfectant can include hydrogen peroxide (as described herein), probiotics (as described here), a surfactant (IVS-34), and an aqueous carrier (distilled water). Another example of a formulation for use as a disinfectant can include hydrogen peroxide (as described herein), probiotics (as described herein), surfactants (SLS and APG), a buffer (citric acid), and an aqueous carrier (distilled water).

Formulations containing hydrogen peroxide and probiotic formulations in accordance with the present disclosure were prepared. In embodiments, one formulation contained 2.4% hydrogen peroxide and the second formulation contained 1.5% hydrogen peroxide. The probiotic composition contained multi-spore bacterial blend. In embodiments, the probiotic composition included 10.5% Bacilox® XL 10× concentrate having a bacterial cell count of 5.5×10⁸ cfu/ml before dilution. Initial cfu counts were about 5.5×10⁷ in the formulations based on the 10.5% use level of Bacilox® XL 10× concentrate. Accelerated stability testing was performed, and there was adequate Bacillus spore survival in samples of both formulations after 12 weeks at 40° C. The samples were analyzed and cfu/ml was reported. Remaining Bacillus were about 5×10⁷ cfu/mi for one sample and about 5×10⁶ cfu/ml for the other. The remaining Bacillus spore counts are expected to be sufficient to provide desired benefits in cleaning products. Stability testing also showed that the hydrogen peroxide was also stable. Additionally, in this formulation, the hydrogen peroxide is used at a low level and would provide limited malodor reduction as an instant effect; however, it is necessary as a preservative for the water based product. It was unexpectedly discovered that a fabric refresher formulation with 0.15% hydrogen peroxide with no added preservatives, which are typically required to keep a cleaning product free from microbial growth through the shelf-life of the product, passed a preservative efficacy challenge testing. This is an important benefit of hydrogen peroxide in the formulations of the present disclosure—to avoid the use of other chemical preservatives that are often objectionable to consumers. As an example, 0.25% hydrogen peroxide can be added to this formulation.

Therefore, the approaches described herein include stable formulations that provide for the incorporation of hydrogen peroxide in microbial cleaning formulas. One would not expect a hydrogen peroxide and probiotic combination to work because hydrogen peroxide has an antimicrobial effect. For example, hydrogen peroxide attacks bacteria on surfaces and therefore one would reasonably expect that hydrogen peroxide would attack the beneficial (probiotic) bacteria spores in a cleaning formulation. Even though probiotic bacteria described herein may be in the spore form and they are still vulnerable to attack and degradation because hydrogen peroxide has known sporicidal effects on bacterial spores. Comparative evaluation of hydrogen peroxide sporicidal efficacy by different standard test methods may be found, for example, on PMC (nih.gov).

Therefore, the cleaning and treating formulations described herein provide a novel combination with unexpected results combining a live probiotic bacteria with hydrogen peroxide. The formulations can be formulated for various uses including refreshing fabrics and disinfecting surfaces.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. As used herein, a material effect would cause a statistically significant difference in the performance of the formulation, for example, cleaning the substrate.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosure and does not pose a limitation on the scope of the disclosure otherwise claimed. No language in the specification should be construed as indicating any non-claimed element essential to the practice of the disclosure.

Groupings of alternative elements or embodiments of the disclosure disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this disclosure are described herein, including the best mode known to the inventors for carrying out the disclosure. Of course, variations on these described embodiments will become apparent to those of ordinary skill in the art upon reading the foregoing description. The inventor expects skilled artisans to employ such variations as appropriate, and the inventors intend for the disclosure to be practiced otherwise than specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

Furthermore, numerous references have been made to patents, printed publications, journal articles, and other written text throughout this specification (referenced materials herein). Each of the referenced materials is individually incorporated herein by reference in their entirety for their referenced teaching.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

Definitions and explanations used in the present disclosure are meant and intended to be controlling in any future construction unless clearly and unambiguously modified in the examples or when application of the meaning renders any construction meaningless or essentially meaningless. In cases where the construction of the term would render it meaningless or essentially meaningless, the definition should be taken from Webster's Dictionary, 3rd Edition, or a dictionary known to those of ordinary skill in the art, such as the Oxford Dictionary of Biochemistry and Molecular Biology (Ed. Anthony Smith, Oxford University Press, Oxford, 2004).

The Exemplary Embodiments and Examples below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### EXEMPLARY EMBODIMENTS

The following are exemplary embodiments.

1. An aqueous cleaning composition comprising: hydrogen peroxide, bacterial spores, and water; and optionally a surfactant.
2. The composition of embodiment 1, wherein the composition comprises from about 0.05% w/w to about 7.00% w/w of the hydrogen peroxide.
3. The composition of embodiment 1 or 2, wherein the composition comprises about 0.5% w/w or about 3.0% w/w hydrogen peroxide.
4. The composition of any one of embodiments 1-3, wherein the bacterial spores are probiotics.
5. The composition of any one of embodiments 1-4, wherein the bacterial spores comprise Bacillus spores.
6. The composition of any one of embodiments 1-5, wherein the bacterial spores comprise spores of at least one of Bacillus subtilis, Bacillus licheniformis, Bacillus pumilus, Bacillus amyloliquefaciens, Bacillus velezensis, Bacillus megaterium, Bacillus atrophaeus, Bacillus mojavensis, Bacillus paralicheniformis, Bacillus thuringiensis, or a combination thereof.
7. The composition of any one of embodiments 1-6, wherein the bacterial spores comprise spores from Bacillus pumilus, Bacillus amyloliquefaciens, Bacillus licheniformis and Bacillus subtilis, and optionally wherein the Bacillus subtilis comprises Bacillus subtilis subspecies inaquosorum.
8. The composition of any one of embodiments 1-7, wherein a colony-forming unit (cfu) of the bacterial spores comprises about 5.0×10⁴ to about 5.5×10⁸ cfu/ml.
9. The composition of any one of embodiments 1-8, wherein the surfactant comprises a nonionic surfactant, a cationic surfactant, an anionic surfactant, or any combination thereof, and optionally, wherein the surfactant comprises a combination of a cationic surfactant and an anionic surfactant.
10. The composition of any one of embodiments 1-9, wherein the surfactant comprises at least one of a polyoxyethylene sorbitan monolaurate, IVS-34, a sodium lauryl sulfate (SLS), or an alkyl polyglucoside (APG).
11. The composition of any one of embodiments 1-10, further comprising a buffer.
12. The composition of any one of embodiments 1-11, wherein the buffer comprises citric acid and/or sodium citrate.
13. The composition of any one of embodiments 1-12, further comprising a stabilizer.
14. The composition of any one of embodiments 1-13, further comprising an acid-based stabilizer, and optionally wherein the acid-based stabilizer is phosphoric acid.
15. The composition of any one of embodiments 1-14, further comprising a fragrance.
16. The composition of any one of embodiments 1-15, wherein the composition comprises by total weight of the composition:
about 0.05% to about 7.00% of the hydrogen peroxide;
about 5.0×10⁴ to about 5.5×10⁸ cfu/ml of the bacterial spores; and
about 78.00% to about 84.00% of the water; and
optionally about 0.20% to about 6.00% of the surfactant.
   17. The composition of any one of embodiments 1-16, further comprising:
about 0.20% to about 6.00% of the surfactant; and
about 0.05% to about 2.00% of citric acid.
   18. The composition of any one of embodiments 1-17, further comprising:
about 0.01% to about 0.05% of phosphoric acid; and
about 0.05% to about 0.50% of sodium citrate.
   19. A method of preparing the composition of any one of embodiments 1-18, the method comprising combining the hydrogen peroxide, the bacterial spores, and the water into an aqueous solution to form the composition.
   20. The method of preparing the composition of any one of embodiments 1-18 and the method of embodiment 19, the method further comprising adding the surfactant, and optionally one or more buffers.
   21. A method of cleaning, disinfecting, and/or deodorizing a substrate, the method comprising applying the composition of any one of embodiments 1-18 to a surface.
   22. The method of embodiment 21, wherein the substrate is a hard surface, an upholstery, or a textile.
   23. The method of embodiment 21 or 22, wherein the substrate is a hard surface comprising a garbage disposal, a sewer system, a sink, a dish washer, or a washing machine.
   24. The method of any one of embodiments 21-23, wherein the substrate is an upholstery or a textile comprising a synthetic fiber in clothing, linens, and/or carpet.
   25. The method of any one of embodiments 21-24, wherein the substrate remains cleaned and refreshed without having to reapply the composition.

### EXAMPLES

Representative embodiments of the present disclosure will now be described with reference to the following examples that illustrate the principles and practice of the present disclosure.

Cleaning and treating formulations were prepared as shown in the Examples below.

### Example 1

TABLE 1

| | | Component Quantity |
|---|---|---|
| Component | Function | (% w/w) |
| DI Water | Diluent | 83.22 |
| Hydrogen Peroxide | Active Cleaning Agent | 0.50 |
| Bacillus spore mix | Probiotic | 10.00 |
| Polysorbate 20 | Nonionic Surfactant | 5.00 |
| Sundried Linen OS SC | Fragrance | 1.00 |
| Phosphoric Acid | Stabilizer | 0.02 |
| Citric Acid | Buffer | 0.07 |
| Sodium Citrate | Buffer | 0.19 |
| Total | | 100.00 |

The formulation of Example 1 provides an example of a formulation for refreshing fabrics and was prepared by combining the DI water, the hydrogen peroxide, the Bacillus spore mix, the polysorbate 20, the sundried linen fragrance, the phosphoric acid, the citric acid, and the sodium citrate. The formulation of Example 1 had a pH of about 4.5-5.5.

The formulation of Example can be used to treat various fabrics. The formulation can be sprayed or applied on the fabric until slightly damp and allowed to air dry.

### Example 2

TABLE 2

| Component | Function | Component Quantity |
|---|---|---|
| Water | Diluent | 83.900 |
| Hydrogen Peroxide | Active Cleaning Agent | 4.280 |
| Bacillus spore mix | Probiotic | 10.500 |
| IVS-34 | Surfactant | 1.320 |
| Total | | 100.00 |

The formulation of Example 2 provides an example of a formulation that may be used as a disinfectant and was prepared by combining the distilled water, the hydrogen peroxide, the Bacillus spore mix, and the IVS-34. The formulation of Example 2 had a pH of about 6-7.

### Example 3

TABLE 3

| Component | Function | Component Quantity |
|---|---|---|
| Water | Diluent | 78.690 |
| Hydrogen Peroxide | Active Cleaning Agent | 6.860 |
| Bacillus spore mix | Probiotic | 10.500 |
| Sodium Lauryl Sulfate | Anionic Surfactant | 0.450 |
| Sucranov HG-NAT | Nonionic Surfactant | 2.500 |
| Citric Acid Anhydrous | Buffer | 1.000 |
| Total | | 100.00 |

The formulation of Example 3 provides an example of a formulation that may be used as a disinfectant and was prepared by combining the distilled water, the hydrogen peroxide, the Bacillus spore mix, the sodium lauryl sulfate, the Sucranov™ HG-NAT, and the anhydrous citric acid. The formulation of Example 3 had a pH 2-3.

1. An aqueous cleaning composition comprising:
hydrogen peroxide;
bacterial spores; and
water; and
optionally one or more surfactants.

2. The composition of claim 1, wherein the composition comprises from about 0.05% w/w to about 7.00% w/w of the hydrogen peroxide.

3. The composition of claim 1, wherein the composition comprises about 0.5% w/w or about 3.0% w/w hydrogen peroxide.

4. The composition of claim 1, wherein the bacterial spores are probiotics.

5. The composition of claim 1, wherein the bacterial spores comprise Bacillus spores.

6. The composition of claim 1, wherein the bacterial spores comprise spores of at least one of Bacillus subtilis, Bacillus licheniformis, Bacillus pumilus, Bacillus amyloliquefaciens, Bacillus velezensis, Bacillus megaterium, Bacillus atrophaeus, Bacillus mojavensis, Bacillus paralicheniformis, Bacillus thuringiensis, or a combination thereof.

7. The composition of claim 1, wherein the bacterial spores comprise spores from Bacillus pumilus, Bacillus amyloliquefaciens, Bacillus licheniformis and Bacillus subtilis, and optionally wherein the Bacillus subtilis comprises subspecies inaquosorum.

8. The composition of claim 1, wherein a colony-forming unit (cfu) of the bacterial spores comprises about 5.0×10⁴ to about 5.5×10⁸ cfu/ml.

9. The composition of claim 1, wherein the one or more surfactants comprise a nonionic surfactant, a cationic surfactant, an anionic surfactant, or any combination thereof.

10. The composition of claim 1, wherein the one or more surfactants comprise at least one of a polyoxyethylene sorbitan monolaurate, a sodium lauryl sulfate (SLS), an alkyl polyglucoside (APG), or a combination of anionic and nonionic surfactants.

11. The composition of claim 1, further comprising a buffer.

12. The composition of claim 11, wherein the buffer comprises citric acid and/or sodium citrate.

13. The composition of claim 1, further comprising a stabilizer.

14. The composition of claim 1, further comprising a acid-based stabilizer, and optionally the acid-based stabilizer is phosphoric acid.

15. The composition of claim 1, further comprising a fragrance.

16. The composition of claim 1, wherein the composition comprises by total weight of the composition:
about 0.05% to about 7.00% of the hydrogen peroxide;
about 5.0×10⁴ to about 5.5×10⁸ cfu/ml of the bacterial spores; and
about 78.00% to about 84.00% of the water; and
optionally about 0.20% to about 6.00% of the one or more surfactants.

17. The composition of claim 16, further comprising:
about 0.20% to about 6.00% of the one or more surfactants; and
about 0.05% to about 2.00% of citric acid.

18. The composition of claim 17, further comprising:
about 0.01% to about 0.05% of phosphoric acid; and
about 0.05% to about 0.50% of sodium citrate.

19. A method of preparing the composition of claim 1, the method comprising combining the hydrogen peroxide, the bacterial spores, and the water into an aqueous solution to form the composition.

20. The method of claim 19, the method further comprising adding one or more surfactants, and optionally one or more buffers.

21. A method of cleaning, disinfecting, and/or deodorizing a substrate, the method comprising applying the composition of claim 1 to a surface.

22. The method of claim 21, wherein the substrate is a hard surface, an upholstery, or a textile.

23. The method of claim 22, wherein the hard surface comprises a garbage disposal, a sewer system, a sink, a dish washer, or a washing machine.

24. The method of claim 22, wherein the upholstery or the textile comprises a synthetic fiber in clothing, linens, and/or carpet.
